(19) United States
(12) Patent Application Publication
(10) Pub. No.: US 2007/0029446 A1
(43) Pub. Date: Feb. 8, 2007

(54) Modular platform architecture for satellites

(76) Inventors: Todd J. Mosher, Littleton, CO (US); Quinn Young, North Logan, UT (US)

Correspondence Address: THORPE NORTH & WESTERN, LLP., 8180 SOUTH 700 EAST, SUITE 200, SANDY, UT, 84070, US

(21) Appl. No.: 11/417,003

(22) Filed: May 2, 2006

Related U.S. Application Data
(60) Provisional application No. 60/677,663, filed on May 2, 2005.

(51) Int. Cl. B64G 1/00

(52) U.S. Cl. 244/158.1

(57) ABSTRACT

A method for implementing a modular platform for the construction of satellites and other spacecraft based on modular platform architecture, the method comprising: (a) identifying a plurality of functional elements and their associated functional routines that may be operable within at least one satellite; (b) associating the functional routines with one another in a strategic manner; (c) dividing the functional routines to define a plurality of subsystems; and (d) deriving a plurality of modules from the plurality of subsystems, each of the modules being configured to operably interface with at least one other module to construct a working satellite capable of carrying out a pre-determined number of the functional routines.

### RELATED APPLICATIONS

This application claims the benefit of U.S. Provisional Application Ser. No. 60/677,663, filed May 2, 2005, and entitled, “Modular Platform Architecture for Small Satellites,” which is incorporated by reference in its entirety herein.

### GOVERNMENT SUPPORT CLAUSE

This invention was made with support from the United States Government, and the United States Government may have certain rights in this invention pursuant to USDOD NATIONAL RECONNAISSANCE OFFICE, NRO000-04-C-0035.

### FIELD OF THE INVENTION

The present invention relates generally to the manufacturing and operation of small satellites, and more particularly to a method and system for constructing and operating small satellites from a modular platform architecture, wherein a plurality of modules containing all of the necessary functional elements of a small satellite are provided and may be operably and selectively assembled together to construct a small satellite and variants thereof.

### BACKGROUND OF THE INVENTION AND RELATED ART

In an era where technology is fast advancing and where a critical need exits for accurate information gathering, particularly in important civil and military missions, there is an increased reliance on various types of spacecraft or satellites to perform or assist in these tasks. Indeed, many in the aerospace industry have dedicated considerable efforts towards the development of spacecraft or satellite systems and subsystems. With technological advances and increased accessibility and availability, satellites are increasingly of interest to both governments and private-sector companies and investors.

Recent advances in materials and electronics have enable increasing performance from ever decreasing component sizes. These changes have enabled satellites, and particularly small satellites, to perform viable missions. The advantage of small satellite systems and subsystems are many, including more rapid development and deployment and decreased costs compared to larger, more expensive satellites. In recent years, the new approach to utilize small satellites has opened up a new class of space applications. As such, the trend towards using small satellites continues today as small satellites remain a viable vehicle for science, information gathering, technology demonstration, remote sensing, communications, and others. Small satellites have opened a window through which low earth orbit may be rapidly accessed at a fraction of the cost demanded by large satellites. The cost to place any object in space, however, can still be exorbitant. Moreover, the cost of a satellite and the harsh environment of space require that every component used to build the satellite be thoroughly tested on Earth prior to the satellite being launched in order to ensure the greatest probability possible that the satellite will function properly in space the duration of its mission.

Most satellites are designed for one specific mission. There is currently a demand for specific capabilities rather than specific platforms. This approach works well for industry programs with large budgets. However, those low cost programs with fixed budgets often require that the design and testing of satellite components be limited in order to reduce costs. In current satellites, there are generally accepted designs for the spacecraft structure, solar arrays, and major subsystems. Although product innovation is still in progress, major platform designs are changing very little. This being the case, one would expect process innovation to be emphasized over product innovation for the spacecraft bus. However, the industry is lagging in this respect. As such, heritage equipment, facilities, and traditional approaches currently drive the manufacturing and operation of small satellites. In spite of this, the industry has continued to mature and move forward with customers demanding both accessibility and affordability.

There is an identified need to create more efficient, flexible, and economical satellites that can provide flexibility in accomplishing various mission types, and that can be successfully deployed by various entities or organizations, including those with limited budgets. Thus, the spacecraft industry may benefit from applying some of the cost-saving methods that have proven successful for auto makers, personal computer manufacturers, and others, namely the production of products based on a platform architecture.

In general, product architecture describes the way in which product functions are divided into physical components, such as the arrangement of functional elements, the mapping of those elements to physical components, and the defining of the interfaces between components. Product architecture may be grouped into two principal types, integral product architecture and modular product architecture. The specific type of architecture that will be best suited for a specific project or mission will vary with the mission objectives, supplier goals, market characteristics or forces and various other factors.

An integral architecture has a complex relationship between functions and physical components. Although integral architecture allows greater performance optimization or short-term cost optimization, areas of flexibility, standardization, and potential long term cost savings are sacrificed. The complex interfaces and interdependencies within an integral architecture also increase the scope of each product change. For example, replacing a star tracker on a spacecraft may change attitude control algorithms, IMU interfaces, control and data handling software, telemetry packets, and wiring harnesses, each of which could cause additional changes to ripple through the system.

The majority of spacecraft being developed today are based on integral product architecture. Within integral product architecture for satellites, designers typically select from a traditional bus or a common or standard bus technology. A typical traditional satellite bus has complex interfaces and highly integrated components with complex mapping of functions to components. There are a number of factors that lead to this type of architecture, including cost, performance optimization, lot size, and market type. Each satellite contract tends to be focused on a very specific mission. The high performance optimization expected of these missions is often achievable only with highly customized and integrated designs. This high degree of customization leads to high unit cost and small unit numbers for individual satellite designs, while at the same time reducing the likelihood of standardization within the spacecraft industry.

The “common” or “standard” bus concepts that have been developed to address the need for greater reuse of satellite investments is a form of “fixed” product portfolio, where variation is minimized across a product line. This bus type is typically an integral architecture with some degree of standardization of functions and interfaces. When variations are minor between satellite products, essentially duplicating the satellite product, or when satellite variations are limited, this option can be very effective at reducing cost, risk, and development time. However, performance requirements, mission focus, and customer expectations can vary significantly between typical satellite projects, thus limiting the usefulness of this type of architecture for satellites. Some satellites, such as large communications satellites, that have a high level of similarity across multiple customers may be able to employ this architecture effectively, but only until initial designs begin to vary between customers or across generations of satellites.

As an alternative to the traditional and “common bus” architectures, modular architectures have been used to create satellites, albeit in limited or partial implementation. Currently, three types of architectures exist—modular shelf architecture, thrust tube and equipment bay architecture, and panel and frame architecture.

The modular shelf architecture type is particularly well suited to designs with common form factors. These designs appear to be strongly influenced by electrical engineering packaging concepts and usually have well-defined electrical and mechanical interfaces between shelves. The removal of heat from the assembly and the fixed interface (particularly where the shelf stack can grow only in one dimension) appear to be the greatest drawbacks for this architecture.

The thrust tube and bay architecture is one regularly used for satellites. This architecture has a central cylinder along the thrust axis for the primary structure with equipment bays around the perimeter of the cylinder. Many satellites use the central portion of the cylinder for the propulsion system. The equipment bays can be modular in nature, or the entire assembly can be an integral module to which the payload and other equipment attach. It appears, however, that the modular structural frame is the only actual modular portion of the architecture. The overall modularity is generally compromised by the level of dependence between each bay. In addition, the mechanical aspects of the modularity do not appear to be coupled with electrical and software modularity, and the interfaces between modules are often not simple or standardized.

The panel and frame architecture divides the power, attitude control, and data handling functions into separate modular panels. These modular panels are attached to a frame, typically triangular or rectangular, that includes the spacecraft and payload interfaces and can include a propulsion module and power generation hardware (solar arrays). This implementation is the most modular of the existing satellite architectures. However, this particular architecture does not adequately address software and structural modularity.

Accordingly, there is a need for a more advanced platform architecture capable of meeting the demands of today and also those of the future, which platform architecture also provides a more viable, effective, and cost-conscious methodology than those currently employed. This type of architecture would address the mechanical, electrical, and software aspects of the interfaces between modules.

### SUMMARY OF THE INVENTION

In light of the problems and deficiencies inherent in the prior art, the present invention seeks to overcome these by applying product architectural selection theory to spacecraft, and particularly satellites, such as small satellites. More specifically, the present invention seeks to provide a modular platform for spacecraft based on modular platform architecture in order to introduce into the spacecraft industry some of the advantages recognized and enjoyed by other industries adopting similar platform architecture methodologies. In short, it is intended that modular platform architecture for satellites provide the ability to create, configure, and reconfigure several variant satellites from a set of interfacing modules, which variants may be designed based on the mission intended for them to perform, and which variants may be created at significant cost savings. Small satellites particularly are well suited to be created based on modular platform architecture due to their cost focus, functional independence, mission similarity, system commonality, process similarity, process independence, and potential for interface standardization.

In accordance with the invention as embodied and broadly described herein, the present invention features a method for implementing a modular platform for the construction of satellites and other spacecraft based on modular platform architecture, the method comprising: (a) identifying a plurality of functional elements and their associated functional routines that may be operable within at least one satellite; (b) associating the functional routines with one another in a strategic manner; (c) dividing the functional routines to define a plurality of subsystems; and (d) deriving a plurality of modules from the plurality of subsystems, each of the modules being configured to operably interface with at least one other module to construct a working satellite capable of carrying out a pre-determined number of the functional routines.

The present invention also features a method for constructing a satellite from a modular platform based on modular platform architecture, the method comprising: (a) obtaining a plurality of modules, each being configured to perform a pre-determined function; (b) selecting a set of the plurality of modules to be used to construct a satellite configured to conduct an intended mission; and (c) interfacing each of the modules within the set with at least one other module to construct the satellite capable of performing all required and optional functional routines.

The present invention further features a modular platform for use in constructing satellite and variants thereof, the modular platform being based on modular platform architecture, and comprising: (a) a plurality of functional elements and their corresponding functional routines that identify the various operations and functions of a satellite; the functional routines being strategically associated with one another; (b) a plurality of subsystems corresponding to and defined by the plurality of functional elements and the functional routines, the subsystems operating to strategically divide and categorize the functional routines; and (c) a plurality of modules, each being derived from at least one of the subsystems, and each being configured to operably interface with at least one other module to construct a working satellite capable of carrying out a pre-determined number of the functional routines.

The present invention still further features a satellite designed for an identified mission comprising: (a) a plurality of independent modules selected and assembled from a modular platform based on a modular platform architecture, each of the plurality of modules being configured to perform a pre-determined function; and (b) means for interfacing each of the plurality of modules with at least one other module in an operable manner to construct the satellite and to facilitate the performance of all functional routines intended to be performed by the satellite.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention they are, therefore, not to be considered limiting of its scope. It will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings in which:

FIG. 1 illustrates a perspective view of a small satellite spacecraft utilizing the modular platform architecture according to one exemplary embodiment of the present invention;

FIG. 2 illustrates a graphical depiction of a satellite configured or constructed from a plurality of satellite modules;

FIG. 3 illustrates a block diagram of the basic functional elements as divided or delineated according to one exemplary embodiment;

FIG. 4 illustrates a block diagram of a modular hierarchy according to one exemplary embodiment of the present invention;

FIG. 5 illustrates a schematic diagram depicting the electrical interaction and interconnection of a plurality of modules and their respective components as selected to form and be incorporated into a small satellite spacecraft according to one exemplary embodiment of the present invention;

FIG. 6 illustrates a detailed block diagram depicting an exemplary electrical interface minimizing the complexity of the interface by reducing the number and type of external interfaces using an attitude determination and control subsystem;

FIGS. 7-A-7-S illustrate several exemplary modules making up the present invention modular platform architecture;

FIG. 8 illustrates an exploded perspective view of several exemplary modules for forming the upper portion of an exemplary modular satellite;

FIG. 9 illustrates an exploded perspective view of several exemplary modules for forming the lower portion of an exemplary modular satellite;

FIG. 10 illustrates an exploded perspective view of several additional exemplary modules that may be utilized with the portions of FIGS. 8 and 9, which additional modules are shown as being used to complete an exemplary modular satellite;

FIG. 11 illustrates a cutaway view of an exemplary assembly of modules to form a portion of an exemplary modular satellite;

FIG. 12 illustrates an exemplary communications platform satellite variant as constructed from a plurality of the several modules existing within the present invention modular satellite platform architecture;

FIG. 13 illustrates an exemplary remote sensing platform satellite variant as constructed from a plurality of the several modules existing within the present invention modular satellite platform architecture;

FIG. 14 illustrates an exemplary rendezvous platform satellite variant as constructed from a plurality of the several modules existing within the present invention modular satellite platform architecture;

FIG. 15 illustrates an exemplary science platform satellite variant as constructed from a plurality of the several modules existing within the present invention modular satellite platform architecture;

FIG. 16 illustrates an exemplary technology demonstration platform satellite variant as constructed from a plurality of the several modules existing within the present invention modular satellite platform architecture;

FIG. 17 illustrates an exemplary responsive space platform satellite variant as constructed from a plurality of the several modules existing within the present invention modular satellite platform architecture;

FIG. 18 illustrates is a table identifying each of the present invention modules utilized in the several exemplary platform satellite variants just described;

FIG. 19 illustrates a table summarizing the spacecraft, payload, and total mass for each of the exemplary platform satellite variants just described; and

FIG. 20 illustrates a power summary for each of the several exemplary platform satellite variants just described.

### DETAILED DESCRIPTION OF EXEMPLARY EMBODIMENTS

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

The following detailed description and exemplary embodiments of the invention will be best understood by reference to the accompanying drawings, wherein the elements and features of the invention are designated by numerals throughout.

The present invention describes modular platform architecture for spacecraft, and particularly satellites, as well as a method and system for designing and manufacturing or constructing satellites from a plurality of modules that are part of modular platform architecture. Unlike an integral architecture approach, the present invention modular platform architecture approach can be implemented to simplify component/module interfaces and interdependencies, and to reduce the scope of each product change as new variants or new generations of the product are developed. The modular platform architecture can be optimized for flexibility, standardization, manufacturability, and others. In addition, the modular platform architecture, if well implemented, can produce significant cost savings over time by allowing greater standardization, reuse of existing designs, de-coupling of manufacturing and assembly processes, and ease of product modification.

Moreover, unlike prior related limited or partial modular platform architectures for satellites, the present invention modular platform goes beyond a simple grouping of components or standardization of interfaces by incorporating thorough modular concepts from the top level down and across individual programs. The present invention modular platform creates a set of modular building blocks that provide the core, or common, function set and modules that are used to differentiate the final satellite variant products. This provides cost savings and risk reduction advantages, and shortens development cycles through the reuse of the common modules and the reuse or standardization of assembly, integration, and test equipment or procedures. This approach allows multiple mission types to be supported by a common set of modules, with variation available where required to support specific mission requirements.

As will be apparent from the detailed description set forth below, with reference to the accompanying drawings, the present invention modular platform architecture for creating satellite variants provides several significant advantages over prior related satellite design and manufacturing methods. Some of these examples include the ability to develop a family of varying systems that can be configured and reconfigured to meet multiple mission requirements at a lower overall cost, thus providing great flexibility; the ability to produce multiple types of satellite variants from a single core platform while maintaining a degree of customization and optimization through module variation (e.g., exchanging battery sizes or reaction wheels depending upon the mission type); the ability to develop the modular platform to create satellite variants capable of performing historical mission types as well as future mission types; a reduction in non-recurring engineering by reusing both satellite components and ground support equipment; process independence; commonality of processes and procedures; commonality of systems, commonality of functions within groups of programs; functional independence of subsystems; efficient testing and integration; standardization of the modular architecture; standardization of modular interfaces, thus reducing the effects of changes, either within a module or by exchanging a module; higher volume production that would benefit system integrators, component suppliers, and the launch vehicle industry through advocating the use of standards; the ability to create a modular platform that can be adapted, reused, and upgraded; the focus on cost objectives rather than performance objectives; long-term cost savings across a family of missions; making the spacecraft industry more affordable and accessible to a greater population; lower experimental costs; the introduction of new technologies, which introduction would be smoother and at a lower risk by limiting the change to individual modules; the ability to reuse previously designed modules in both localized and non-localized areas, thus saving the cost and efforts of redeveloping subsystems; a reduction in design risk; the ability to replace the use of traditional and common satellite bus technology prevalent in prior related satellite manufacture; the ability to support a large degree of flexibility and customization as a result of the satellite variants being able to target different mission types, with each satellite variant being derived from the modular platform and part of a family of variant products; the ability to provide a bus built with modules that allow various equipment, systems, etc. to be adaptable for a number of different mission types; an increase in potential design variation; the ability to ease the incorporating of new technology or new variations by limiting the scope of individual changes on the system; a reduction in effort required to introduce new technology within a single module due to the ease of exchanging a module and the standardization of the modular interface; and others. It is specifically noted that the aforementioned advantages are not meant to be limiting in any way. Indeed, those skilled in the art will appreciate that other advantages may be realized, other than those specifically recited herein, upon practicing the present invention.

The following definitions are provided for reference. Specifically, the term “modular platform architecture,” as used herein, shall be understood to mean the methodology in which a set of interfacing modules, each being able to be configured to perform one or more functions or functional routines, may be selected to construct or create a number of satellite variants from a subset of base modules.

The term “modular platform,” as used herein, shall be understood to mean an implemented platform for constructing satellites and other spacecraft using a plurality of modules, wherein the modular platform is based on modular platform architecture. The modular platform will have identified the various functional routines of a satellite, which functional routines may be grouped together or categorized to provide a plurality of subsystems. From these subsystems, all of the modules within the modular platform may be defined.

The term “modular platform architecture,” as used herein, shall be understood to mean the type of product architecture used to construct satellites and other spacecraft, and variants thereof, and on which the modular platform is based. The modular platform architecture contemplates the division of a satellite or other spacecraft and/or variants thereof into separate parts, and includes, but is not limited to, physical divisions and/or functional divisions, such as a division of the various functional routines of the satellite.

The term “module” or “satellite module,” as used herein, shall be understood to mean a structure, system, or component derived from one or more subsystems, that is part of a modular platform, that is configured to perform one or more specific functions or functional routines, and/or that is configured to interface with at least one or more additional modules to form a satellite and/or variants thereof.

The term “functional routine,” as used herein, shall be understood to mean a function that is either required or optional for the construction, launch, or operation of a satellite, and that is capable of being performed or carried out by one or more modules as included within a modular satellite.

### Top-Level Down Modular Platform Architecture

The present invention modular platform architecture is intended and configured to provide a top-level down approach to the creation of satellites and satellite variants. One exemplary basis for implementing this approach is the division of functions or functional routines of a satellite to provide, in a grouped or categorized manner, a plurality of subsystems, which subsystems are used to derive core and other modules corresponding to and that are capable of performing one or more satellite functions or functional routines. Indeed, the division of common functions and variations may be utilized to provide a well designed, flexible modular platform for satellites. The present invention also contemplates the derivation of several different satellite variants from a plurality of available modules.

Areas of functional commonality are easily seen in the subsystems typical of spacecraft. Attitude control, attitude determination, data processing, commanding, telemetry, communications, power generation, and power storage are common functions that all, or nearly all, satellites perform, and that typically serve as the delineating basis for the subsystems of a satellite. Exemplary present invention modules may be designed and derived from these areas of commonality by carefully dividing them according to these distinct, common subsystems and their corresponding functions. Where functions and performance are similar, the same module may be used. Where different, other modules may be created that scale the performance appropriately, eliminate the function if not required, or replace it with other methods of performing the same function.

In addition to common modules, interfaces to the modules may be configured to have a defined level of standardization and commonality. For instance, the replacement of one battery with another is greatly simplified if all interfaces (mechanical, electrical, and software) are common. As such, it will most likely be desired to minimize the number of unique interfaces needed to create a given number of satellite variants intended for different missions. However, the modular platform may be configured to provide any number of interfaces that may be necessary.

Variation or variables may be typical within some subsystem functions, as well as within specific missions. Lifetime and orbital parameters, such as altitude, inclination and pointing requirements, are a few examples of mission specific variations. Moreover, performance requirements, methods of momentum dumping and station keeping, levels of power generation and storage, accuracy of attitude determination and control, and data processing requirements are examples of variables that may be taken into account for a satellite mission.

Although variations can be significant between classes or families of satellite variants, it is intended that much of the hardware and components may be designed to be common within a class or family of satellites. Where variation is required and where the divisions of functions and modules will best serve commonality and variation will largely be dependent upon the types of satellite variants to be created and their intended missions.

The present invention modular platform architecture further considers the level of functional independence. The traditional separation of satellite functions or functional routines into subsystems enables a high degree of functional independence. Although there can be a high degree of coupling within a subsystem, traditionally the subsystems have been designed, tested, and integrated with a high level of functional independence. This independence allows for a high degree of modularity, and such subsystems may be the basis for the modules of the modular platform.

The present invention modular platform architecture further provides for the standardization of the modular interface, in whole or among subgroups. For existing small satellite components there is not a well-defined standard for mechanical, electrical, or software interfaces. Many of these components have adopted the Mil-Std-1553 or RS-422 standards for electrical interfaces, but these standards are far from universal. Nonetheless, standardization implementation may be provided, which standardization may be based on existing or other standards. Despite the standardization achieved, it is contemplated that the modular platform architecture will provide some level of flexibility to accommodate components that are not easily adapted to the standard modular interface.

Although separate issues, process independence and process commonality are related and overlapping. The degree to which manufacturing, assembly, integration, and testing processes are independent from one another and the degree to which each process is similar is heavily dependant on product architecture. For small satellites there is much that is independent, much that is common, and much that is combined. The traditional division of subsystems allows many of the assembly and testing processes to run in parallel.

The modular satellite components may be subjected to various tests required to qualify them for inclusion in the modular platform architecture, and for creating a satellite variant. For example, each modular component may be tested for vibration levels, thermal cycling, and a variety of other performance or functional capabilities. Electrical components usually require testing of electromagnetic signature and interference sensitivity.

A number of financial and schedule advantages can be realized by creating commonality of processes. A common qualification process, for example, may create efficiencies both by reducing the number of different processes, the training required for each process, and the non-recurring engineering required to create each process.

Independence of processes can occur simultaneously with process commonality. For instance, a common qualification process that is independent of design processes or assembly processes, except in the order in which they occur, simplifies the creation and flow of each individual process.

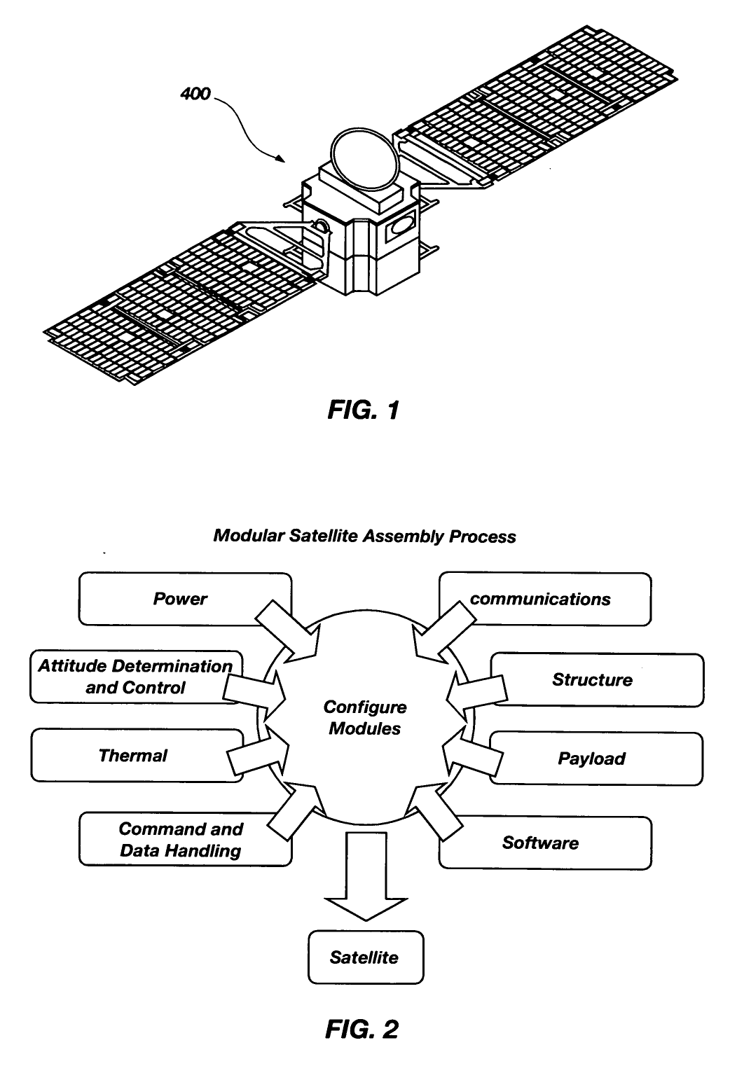

With reference to FIG. 1, illustrated is a perspective view of one exemplary embodiment of a small satellite spacecraft constructed from a modular platform based on the modular platform architecture of the present invention. Specifically, FIG. 1 illustrates a communications satellite variant 400 constructed from a plurality of specifically selected modules operable with one another to form the satellite variant 400. The several modules, which are discussed in greater detail below, operably interact or interface with one another in one or more ways, such as mechanically and/or electrically, and are configured to provide or perform all of the required functions or functional routines specific to a communications-type satellite. As will be shown below, other types of satellite variants may be constructed by selecting a set of core and other modules configured to interface with one another.

FIG. 2 illustrates a diagram of an exemplary modular satellite design. From this diagram it can be seen that the satellite design includes several elements or components for proper construction and operation. Some of the identified components of a satellite include, but are not limited to various structural components, power supply and management components, communications components, command and data handling components, software and electrical components, attitude determination and control components, and thermal components. Each one of these is shown being operable with the propulsion components. Those skilled in the art will recognize that other satellites may comprise more or less than the elements described here and shown in FIG. 2.

As briefly alluded to above, one of the characteristics of the present invention modular platform architecture is the identification and delineation of the various functions or functional routines that may be used in the construction, launch, and operation of a satellite. There are several of such functional routines known in the art, or that are currently being developed that may be incorporated into satellites, and particularly the construction and operation of small satellites utilizing the modular platform technology of the present invention. As such, the present invention comprises identifying, dividing and associating, as needed, the various functional routines that may serve as the basis for developing the various subsystems of the present invention modular platform architecture, which subsystems may be used to derive several modules to be incorporated into a satellite spacecraft constructed using the present invention modular platform approach.

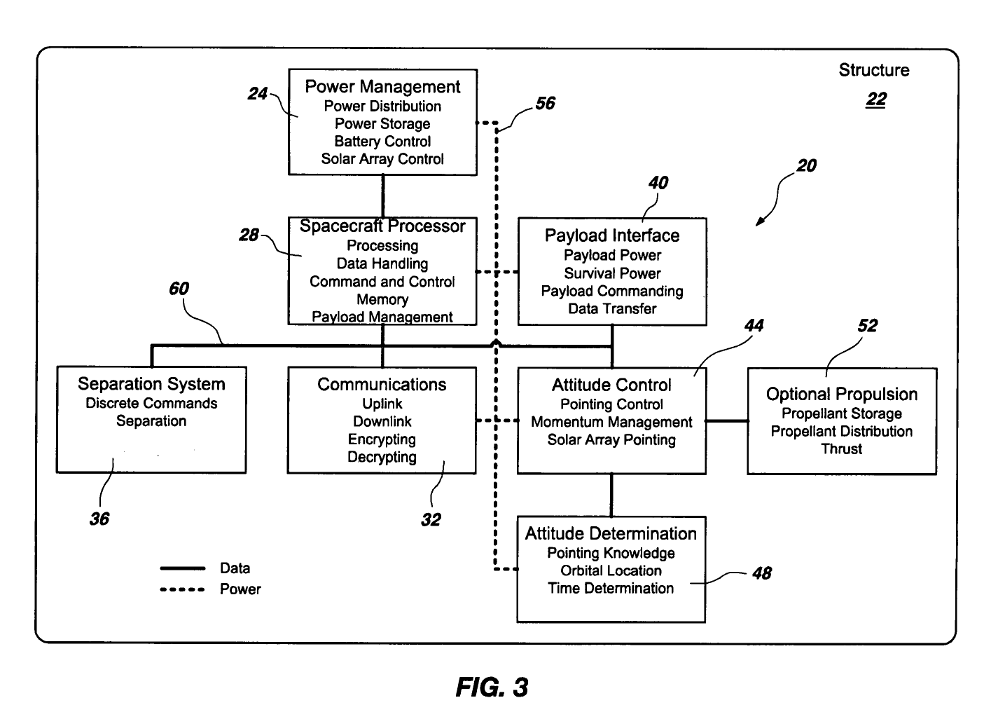

With reference to FIG. 3, illustrated is a block diagram of several exemplary functional elements as identified and divided or delineated in accordance with one exemplary embodiment, wherein each functional element is configured to perform at least one function or functional routine within a constructed satellite variant. As shown, the functional element layout 20 is contained within a structural element 22, and comprised of several functional elements, namely power management 24, spacecraft processor 28, communications 32, separation system 36, payload interface 40, attitude control 44, attitude determination 48, and optional propulsion 52 elements. These functional elements and their divisions, although known in the art, identify and account for the necessary and/or optional functions or functional routines of a satellite, and operate to define the building blocks of the present invention modular platform architecture. More specifically, these functional elements may help to define or delineate the present invention subsystems, which subsystems are used to derive one or more exemplary modules of the modular platform. Of course, one skilled in the art will recognize that other functional elements may be identified and included in addition to those identified herein. In addition, one skilled in the art will recognize that the identified functional elements may be divided or delineated in a different manner than shown in the figures and discussed herein. Therefore, the exemplary identified functional elements and their exemplary divisions are not meant to be limiting in any way.

The power management functional element 24 provides several functions, including, but not limited to, power distribution, power storage, battery control, and solar array control. The spacecraft processor element 28 provides several functions, including, but not limited to, processing, data handling, command and control memory, and payload management. The communications functional element 32 provides several functions, including, but not limited to, uplink and downlink communications, encrypting, and decrypting. The separation functional element 36 provides several functions, including, but not limited to, discrete commands for separation. The payload interface functional element 40 provides several functions, including, but not limited to, payload power, survival power, payload commanding, and data transfer. The attitude control functional element 44 provides several functions, including, but not limited to, pointing control, momentum management, and solar array pointing. The attitude determination functional element 48 provides several functions, including, but not limited to, pointing knowledge, orbital location, and time determination. The optional propulsion functional element 52 provides several functions, including, but not limited to, propellant storage, propellant distribution, and thrust. It is noted that the structural element 22 is intended to illustrate the support for the various functional elements within the functional element layout 20. Although shown as such, the structural element 22 is not necessarily intended as a single structure supporting each of these.

Moreover, as can be seen, power management 24, spacecraft processor 28, communications 32, separation system 36, payload interface 40, attitude control 44, attitude determination 48, and optional propulsion 52 elements are each operably interconnected or interfaced to exchange data through a suitable data transmission line 60, as indicated by the solid lines representative of the data transmission line 60. In addition, power management 24, spacecraft processor 28, communications 32, payload interface 40, attitude control 44, and attitude determination 48 elements are each electrically and operably interconnected, as indicated by the dotted lines representative of a suitable power line 56.

As indicated, the subsystems of a small satellite may be derived from various functional elements and their divisions, such as those described above. The present invention seeks to advance the development and implementation of these functional elements and resulting subsystems into satellites by providing a modular approach to the building and operation of satellites. In order to accomplish this, the functional elements and their divisions, or any others identified and delineated, are essentially divided and used to define individual subsystems, with one or more modules being derived from each subsystem.

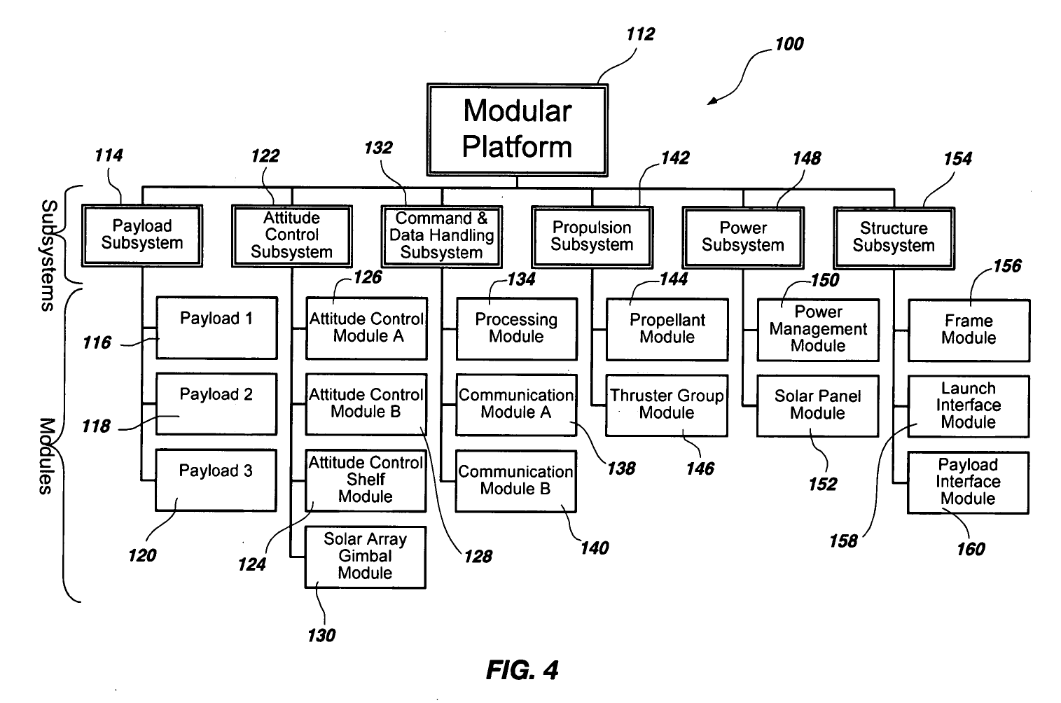

With reference to FIG. 4, illustrated is a block diagram depicting modularity hierarchy within a modular platform architecture according to one exemplary embodiment of the present invention. Specifically, FIG. 4 illustrates a graphical depiction of an exemplary modular platform architecture 100 featuring an exemplary modular platform 112 comprising a plurality of identified and delineated subsystems, with each subsystem comprising individually selectable and interactive modules. The subsystems may be based on the functional elements of FIG. 3. As shown, the present invention features a modular platform 112 comprising a payload subsystem 114, an attitude control subsystem 122, a command and data handling subsystem 132, a propulsion subsystem 142, power subsystem 148, and a structure subsystem 154. These subsystems, and more particularly the modules making up these subsystems, may be selectively and operably interfaced or interconnected with one another, such as through the use of mechanical, electrical, and/or software connection means, to interact with one another to perform all required and optional functional routines of a specifically constructed satellite variant, and to provide the components and systems necessary to create the satellite variant, as well as different variants thereof.

For exemplary purposes only, payload interface subsystem 114 is shown as comprising a first payload module 116, a second payload module 118, and a third payload module 120. The number of payload modules may vary depending upon the specific mission. The payload subsystem 114 contains the upper deck with electrical and mechanical interfaces to each payload.

The attitude control subsystem 122 is shown as comprising an attitude control shelf module 124, a first attitude control module 126, a second attitude control module 128, and one or more solar array gimbal modules 130.

The command and data handling subsystem 132 is shown as comprising a processor or processing module 134, a first communications module 138, and a second communications module 140. This grouping allows multiple modules with interdependent functions and interfaces to be tested together as a unit prior to system level testing.

The propulsion subsystem 142 is shown as comprising a propulsion or propellant module 144, and one or more thruster group modules 146.

The power subsystem 148 is shown as comprising a power management module 150, and a solar panel module 152.

The structure module 154 is shown as comprising one or more frame modules 156, a launch interface module 158, and a payload interface module 160. The launch interface module 158 may include the bottom panel for the spacecraft, closing that end of the structure, the separation mechanism, and the electrical interface to the launch vehicle.

These divisions and resulting modules function to enable standard or other interfaces and minimal interdependence. Preferably, the design allows a reduction in non-recurring engineering, testing, and risk of undetected problems compared to traditional methods while maintaining a high level of configuration and modularity within each satellite assembly.

As indicated, the modules may be operably coupled together and interfaced to construct a satellite or satellite variant. The modules may be interconnected and operably coupled to one another via an electrical, mechanical, and/or software interface or interconnection. In regards to an electrical interface, a standardized backbone for data transfer and for power transfer may be implemented. A backbone reduces the interdependence of the subsystems and improves the modularity of the system. The data transfer backbone may utilize a standard high-speed serial link, which may use the common RS422/485 protocol, or other more advanced protocols, such as TCP/IP or USB. The protocols can be considered a modular portion of the assembly. With replacement of the harness adapters at each panel and the I/O cards in the processors, the system could easily switch between one protocol and another.

The electrical backbone for the platform may include redundant lines for unregulated 28 V power, +15 V power, +/−5 V power. Additional power lines could be included for other voltages, for a separate survival heater power line, or other needs. The power management module requires a separate circuit to transfer power from the solar arrays (and locally from the batteries) to the modules. This circuit could be contained within the electrical backbone, but would be more efficient as a separate harness that used the same routing locations and attachment fixtures used for the other backbones.

Other harnessing may be implemented for transferring RF signals to and from antennas as well as between communications panels. Some payloads may require a high-speed interface to the main satellite processor. A high-speed data transfer line could easily be added using the same routing locations and attachment fixtures used for other harnessing.

With regards to a mechanical interface, simplifying and standardizing the mechanical interfaces reduces the number of drawings and handling fixtures, as well as simplifying many of the processes the modules will go through (e.g. vibration testing, thermal vacuum testing, assembly). Pursuant to the present invention modular platform design, the interfaces may be standardized within each category. The panels may all have identical interfaces to the frames. The frames may have identical interfaces to each other or to the top and bottom panels. The methods for attaching individual structural components or boxes may also be standardized to the extent possible.

Honeycomb panels, which have become a staple of low-mass space structures, are preferred. By using a standard insert that has not been drilled or threaded, several bolt sizes can be accommodated by the same part. This method also simplifies alignment issues by allowing the location of bolt holes to take place with precision drilling after the less precise panel assembly process. The same standardization and part reduction methodology used for the structure in general may also be applied within the individual and independent modules where possible. For example, the thruster mounting brackets and propellant line supports may be identical.

With regards to a software interface, software for the platform may be designed specifically for the present invention modular platform architecture. The concept of drivers used in the computer industry is an example of the type of software architecture that could be implemented. Each module may comprise an associated driver that allows the software to identify itself and other modules, communicate with these modules, and appropriately command one or more module. The harness adapters at each module can include module identification and configuration data that allows the processor to automatically configure the module, similar to the plug and play components found in the computer industry. This capability would remove much of the reconfiguration effort required when different modules are re-located or replaced with alternates.

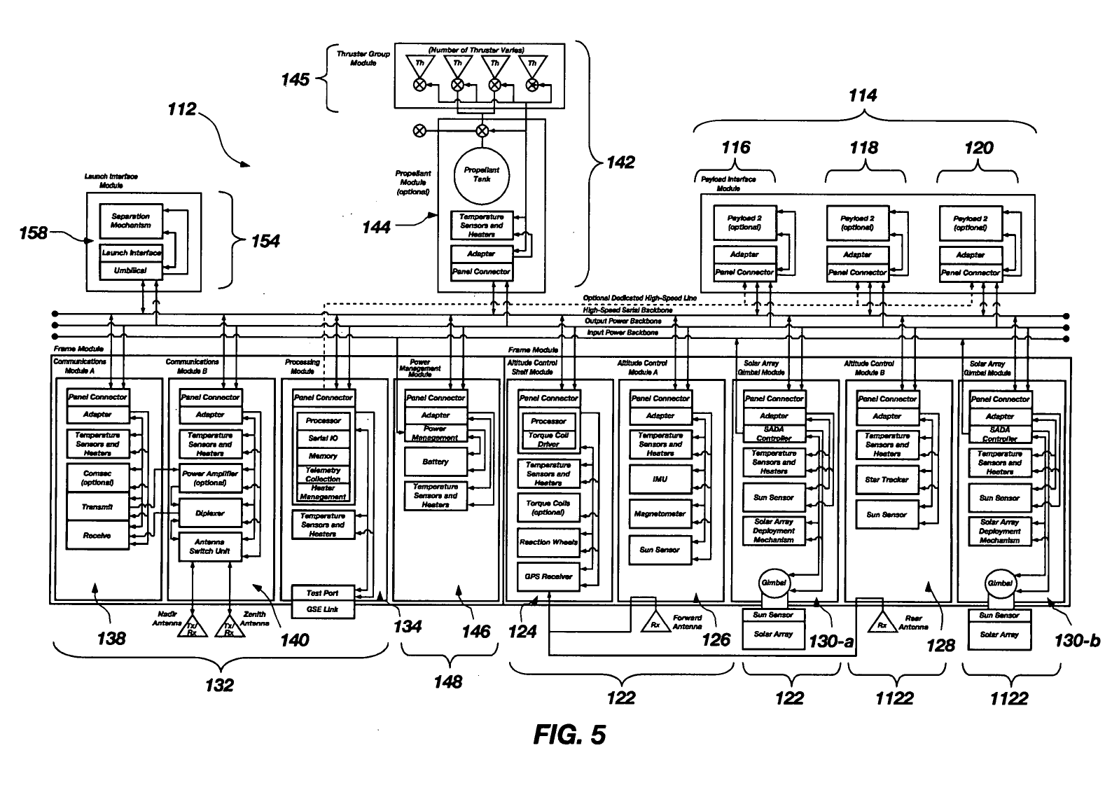

With reference to FIG. 5, illustrated is a schematic diagram depicting the electrical interaction and interconnection or interface of a plurality of subsystems and their respective plurality of modules and components as selected to form and be incorporated into a specific satellite, which electrical interface is shown in accordance with one exemplary embodiment of the present invention. FIG. 5 illustrates specifically the different electrical interface connections existing between the various modules, wherein these electrical interfaces enable the individual modules to function together as a system. The individual modules may be directly interfaced, or through one of the high-speed, output power, and/or input power backbones. Optionally, a dedicated high-speed line may be implemented.

As can be seen, the modular platform 112 comprises each of the subsystems identified in FIG. 4, namely a payload interface subsystem 114, an attitude control subsystem 122, a command and data handling subsystem 132, an optional propulsion subsystem 142, a power subsystem 148, and a structure subsystem 154, as well as their various modules as identified above (see FIG. 4). Indeed, the modules are each configured so that any components operable therewith may mechanically and/or electrically interact with the components of at least one other module. Individually or in an assembled state, the modules perform the necessary functional routines of a satellite. Each of the modules may be formed using known manufacturing methods.

Within the payload subsystem 114 is the payload deck comprising first payload module 116, second payload module 118, and third payload module 120. Each of these is structurally supported and configured to operably interface (e.g., electrically connect or couple) with at least one or more system backbones. The attitude control subsystem 122 comprises an attitude control shelf 124, a first attitude control panel 126, a second attitude control panel module 128, a first solar array panel 130-a, and a second solar array panel 130-b, each of which are electrically connected or operably interfaced with one or more system backbones. The command and data handling subsystem 132 comprises a first communications panel module 138, a second communications panel module 140, and a processor module 134, each of which are also operably interfaced with one or more system backbones. The propulsion subsystem 142 comprises a propellant or propulsion module 144 and one or more thruster group modules 146. The thruster group module 146 is configured to operably interface with the propulsion module 144, which is configured to operably interface with one or more system backbones. The power subsystem 148 comprises the power management module 150, which is operably interfaced with one or more system backbones. Finally, a portion of the structure subsystem 154 is illustrated, wherein the launch interface module 158 is operably interfaced with one or more system backbones.

FIG. 5 further illustrates each of the modules as comprising a panel connector. Each panel connector is supported by the structural components making up the individual module, and is configured to physically or mechanically connect its respective module to at least one other module.

Within the context of the present invention, each module is configured to be part of a modular platform, and thus may be selectively utilized with other modules to form a satellite. Moreover, some modules may be generic, meaning that they may be used on a number of different satellite variants. Other modules may be variant-specific. Therefore, the type of satellite variant desired for construction will determine the set of modules selected.

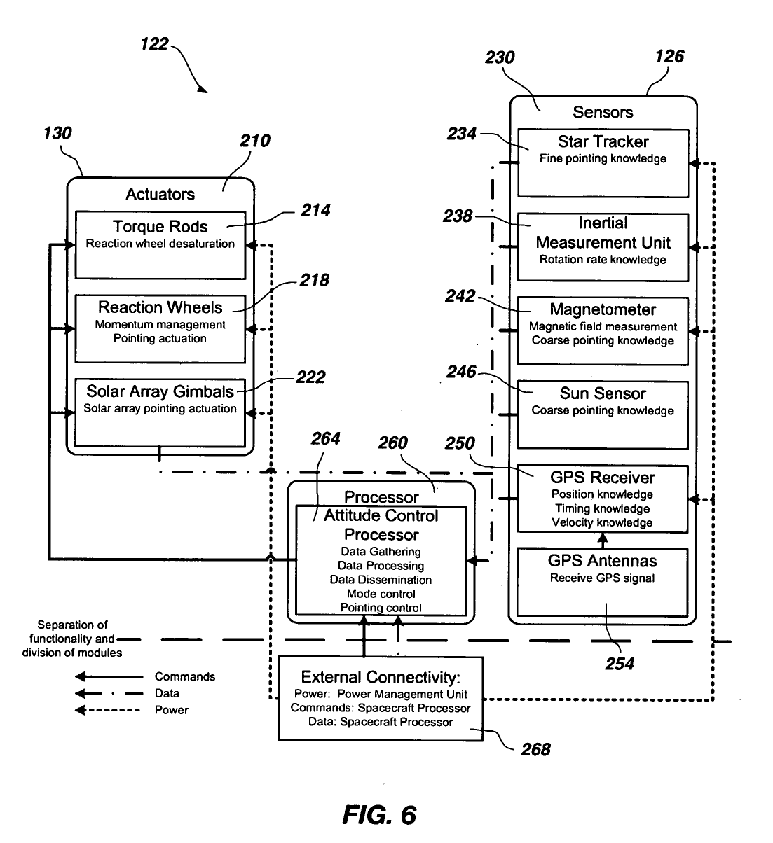

With reference to FIG. 6, illustrated is a detailed block diagram depicting several of the exemplary modules and associated module components that may be operable within the attitude determination and control subsystem of the present invention modular platform. FIG. 6 is intended to provide a detailed look at the various modular components of some of the modules that make up one of the subsystems of the present invention modular platform architecture. FIG. 6 illustrates the reduced complexity apparent to one skilled in the art of the electrical and data interfaces between the attitude control modules and other modules. Other subsystems are not described in detail herein, but exemplary modules and their associated modular components are shown in FIG. 5.

Specifically, FIG. 6 illustrates the attitude control and determination subsystem 122 as comprising various modular components in the form of actuators 210, sensors 230, processor 260, and the necessary external connectivity components 268. Actuator components 210 may further comprise torque rods 214, reaction wheels 218 and solar array gimbals 222, each of which are configured to be powered via the power management unit of the external connectivity components 268. These are also configured to receive commands from the attitude control processor 264, and data from the various sensors 230 and the processor 264. Sensor components 230 may further comprise a star tracker component 234, an inertial measurement unit 238, a magnetometer 242, a sun sensor 246, a GPS receiver 250, and a GPS antenna 254. These also are configured to be powered by the power management unit of the external connectivity component 268, as well as to communicate data to the processor 264 and the various actuators 210.

The processor 260 may comprise any processor type known in the art, or dedicated, modular, and scalable processors not typically used in satellites. The use of a dedicated, modular, scalable processor adds independence and improved functionality to the overall modular platform design. Indeed, using a dedicated processor greatly simplifies the interfaces between the attitude control subsystem and other subsystems by reducing the interface to comprise standardized commands and data. The algorithms, other software, customized connections to the multitude of sensors, and customized commanding instructions can be contained within this group. Changes in the attitude control subsystem will have very limited effects on the rest of the satellite, if at all. The effects of incremental changes in technology (e.g. changing the star tracker or reaction wheels) can be contained within a single module grouping allowing the verification and qualification testing of the modified hardware to be minimized. By including the solar array gimbals within the attitude control subsystem, the interfaces to other modules of other subsystems have been minimized and are limited to the simplest forms of interface (e.g. standardized commanding, telemetry, power, and mechanical interfaces).

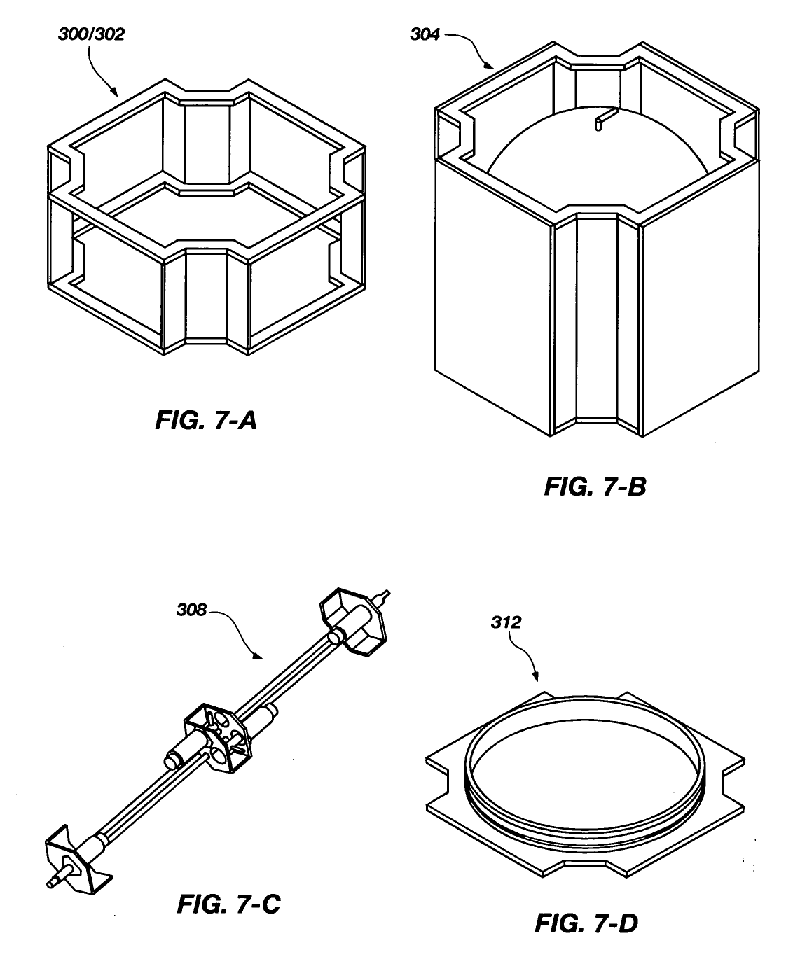

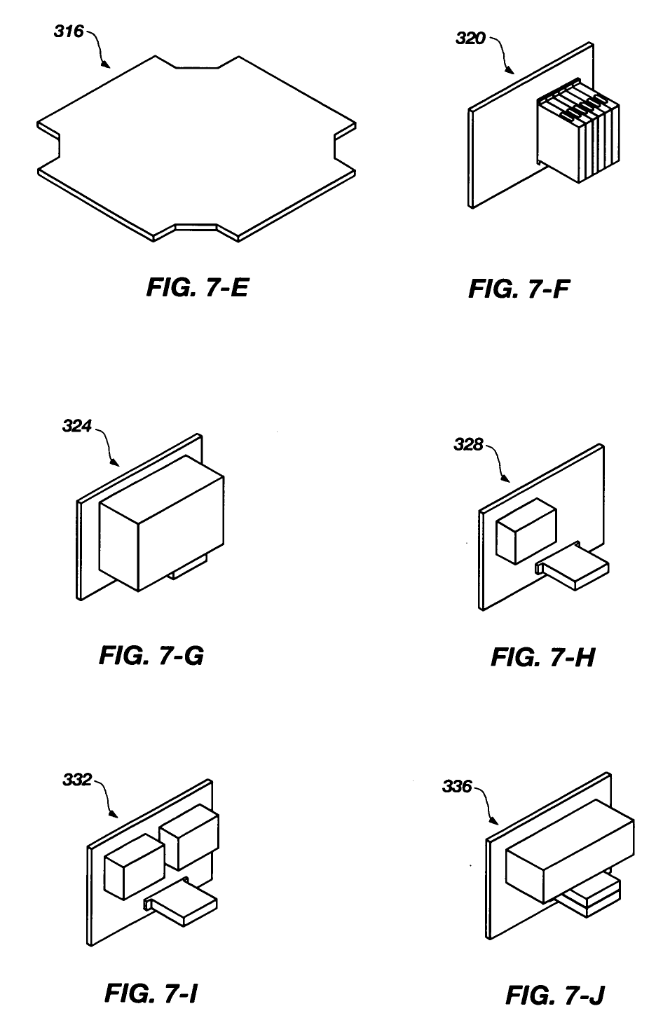

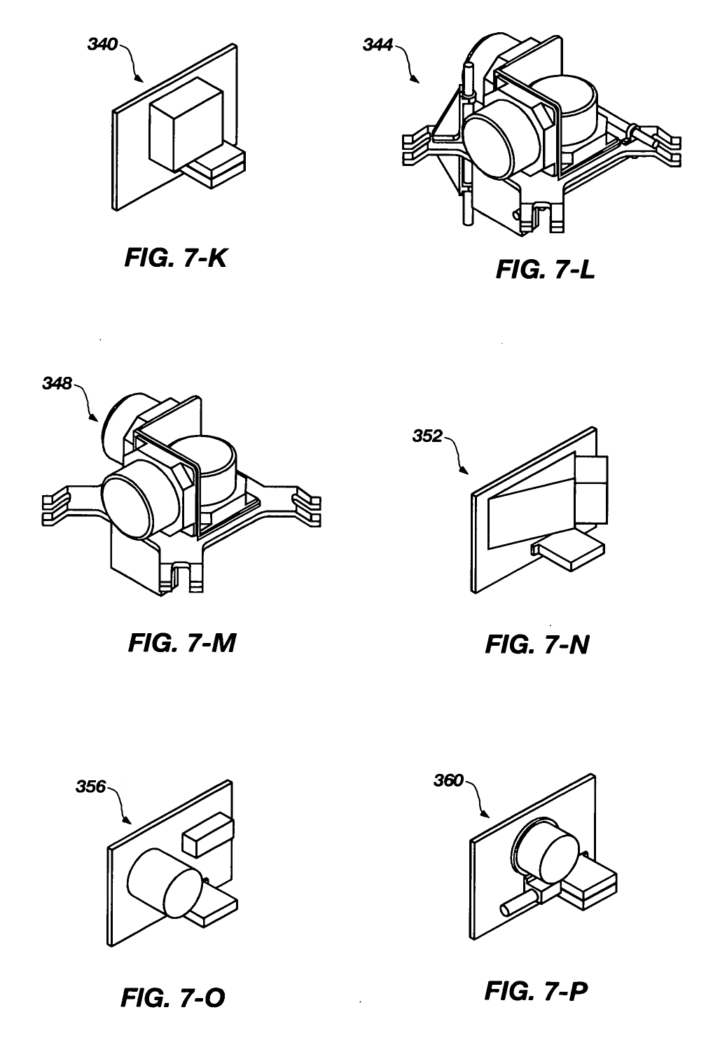

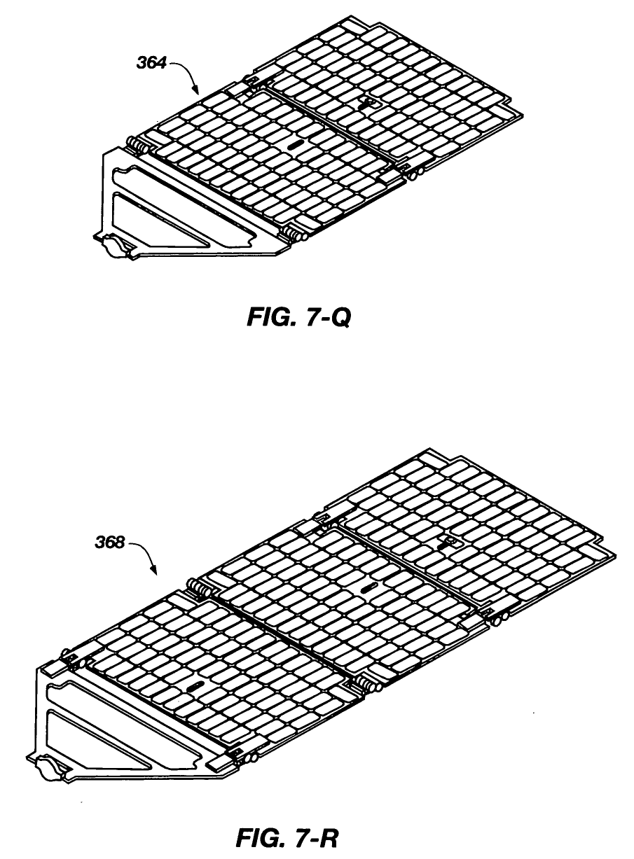

FIGS. 7-A-7-R illustrate several specific exemplary modules for creating one or more satellite variants. Each of these modules may be developed and selected to interface with at least one other module for the purpose of constructing a satellite and/or variants thereof. Each individual module may be configured to be independent of the others, and part of a designated subsystem and an exemplary modular platform, such as the one described above. Thus, each module is capable of releasably connecting to and interacting and operably interfacing with at least one other module in an assembled state. It is noted that not every satellite variant capable of being constructed will utilize all of the available modules. Indeed, some modules may be variant-specific, while others may be generic and usable across a plurality of satellite variants.

As there are many functioning components or elements of a satellite, it follows that the several modules that are part of the present invention modular platform may comprise one or more of these, such as a support structure, a processor, a complete and self-contained or interdependent system, a stand-alone object, a sensor, an actuator, and any other functioning component or element. Depending upon the intended mission and the specific type of satellite to be launched to fulfill the mission, different modules and groups of modules may be selected and assembled together. Being part of an overall modular platform, each individual or separate module shown in FIGS. 7-A-7-R comprises pre-determined interfaces, namely mechanical, electrical, and/or software interfaces. Whichever modules are needed, these are selected and assembled together after a sort of a plug-and-play format to construct a satellite capable of being launched and operated to complete the intended mission.

The various modules discussed below and shown in FIGS. 7-A-7-R are not to be considered limiting in any way. These are merely exemplary in both design and function. Indeed, those skilled in the art will recognize other modular designs that may be incorporated and that fall within the scope and spirit of the present invention.

FIG. 7-A illustrates an exemplary structural module in the form of a frame 300, which may more particularly be used either for a data handling or attitude control structural module. With respect to the data handling structure module, the frame 300 provides the necessary structural support for coupling the various data handling modules that are part of the data handling subsystem, which data handling modules include, but are not limited to, the spacecraft processor panel module, communication panel modules, such as communication panel modules A and B, and the power management panel module. When operably assembled and interconnected, the data handling modules makeup the data handling subsystem and provide all spacecraft processing, data handling, command, telemetry, communications, and power management functions.

With respect to the attitude control structural module, the frame 302 provides the necessary structural support for coupling the various attitude control modules that are part of the attitude control subsystem, which attitude control modules include, but are not limited to, the attitude control shelf module, the attitude control panel A module, the attitude control panel B module, and the solar array gimbal modules. When operably assembled and interconnected, these modules makeup the attitude control subsystem and provide all attitude control functions with the exception of the optional propulsion functions associated with the propulsion subsystem.

FIG. 7-B illustrates an exemplary propulsion module 304. The propulsion module 304 comprises the propellant tank and plumbing required for utilizing the propulsion module. The tank shown is capable of storing approximately 32 kg of hydrazine propellant.

FIG. 7-C illustrates an exemplary thruster group module 308. The thruster group module 308 is shown as comprising four thrusters, two at the center that are offset from one another by ninety (90) degrees, and one at each end of the thruster module 308. Assembling a thruster group module similar to the thruster module 308 at each quadrant of the platform structure, the constructed satellite will comprise a total of sixteen thrusters. However, a satellite may be configured with any number of desired thrusters or thruster modules.

FIG. 7-D illustrates an exemplary launch interface deck module 312. The launch interface deck module 312 is configured with the separation mechanism as well as a connector for electrically connecting to and interfacing with a launch vehicle.

FIG. 7-E illustrates an exemplary payload interface deck module 316. The payload interface deck module 316 provides a plurality of electrical interfaces for payloads as well as thermal and mechanical interfacing. The payload interface deck module 316 may embody a generic, modular interface to the payloads or embody a customized panel with the appropriate modular interfaces to the spacecraft, as required.

FIG. 7-F illustrates an exemplary spacecraft processor panel module 320. The spacecraft processor on this panel comprises the main command, telemetry, memory, and data processing unit for the satellite.

FIG. 7-G illustrates an exemplary communications panel module 324 (transponder). The communications panel module 324 is shown as comprising a SGLS transponder with encryption capability. The nominal RF output power of this particular module is approximately 5 W.

FIG. 7-H illustrates another exemplary communications panel module 328. This particular communications panel does not comprise a power amplifier and functions as a companion to the communications panel module 324 discussed above and shown in FIG. 7-G. The communications panel module 328 may be configured to direct the RF signal from the transponder or the input signal from the antennas using a diplexer.

FIG. 7-I illustrates still another exemplary communications panel module 332, which does comprises a power amplifier. The communications panel module 332 is a variant of the communications panel module 328 shown in FIG. 7-H, and is shown as comprising a diplexer and an RF power amplifier as well as RF signal routing. The power amplifier functions to boost the RF power, such as to 15 W or greater.

FIG. 7-J illustrates an exemplary power management panel module 336. The power management module 336 includes power conditioning and power management electronics as well as the battery used for power storage. Input power from the solar arrays is routed directly to this module. The power management module 336 comprises a battery, such as an 8.0 amp-hour lithium-ion battery.

FIG. 7-K illustrates another exemplary a power management panel module 340. This particular power management panel module is similar to the one described above and shown in FIG. 7-J, but comprises a smaller battery, such as a 3.6 amp-hour lithium-ion battery.

FIG. 7-L illustrates an exemplary attitude control shelf module 344 with torque rods. The attitude control shelf module 344 comprises a processor for attitude control, thus allowing independence of the attitude control software and algorithms from other modules, three reaction or momentum wheels, three torque rods, and a Global Positioning System (GPS) receiver.

FIG. 7-M illustrates another exemplary attitude control shelf module 348 that is similar to the one described above and shown in FIG. 7-L, except it does not comprise torque rods. The attitude control shelf module 348 may be primarily used to construct a satellite that includes a propulsion module.

FIG. 7-N illustrates an exemplary attitude control panel module 352. The attitude control panel module 352 comprises a low power, light-weight star tracker for primary attitude determination, and a wide angle sun sensor.

FIG. 7-O illustrates another exemplary attitude control panel module 356. The attitude control panel module 356 is shown comprising a magnetometer, wide angle sun sensor, and inertial measurement unit.

FIG. 7-P illustrates an exemplary solar array gimbal panel module 360. The solar array gimbal panel module 360 comprises a solar array drive motor with slip rings, solar array deployment mechanism, wide angle sun sensor, and an electronics card for control of the motor, deployment mechanism, and power transfer.

FIG. 7-Q illustrates an exemplary solar array assembly module 364. The particular solar array assembly module shown here comprises a 1-year EOL power generation capability of 107 W using two modular solar panels of four strings each when normal to the sun. The solar array assembly module 364 further comprises a wide angle sun sensor. Each modular solar panel is identical, reducing the number of unique components, test hardware, drawings, and procedures.

FIG. 7-R illustrates another exemplary solar array assembly module 368. This particular solar array assembly module comprises 1-year EOL power generation capability of 161 W using three solar panels of four strings each when normal to the sun. This assembly also includes a wide angle sun sensor.

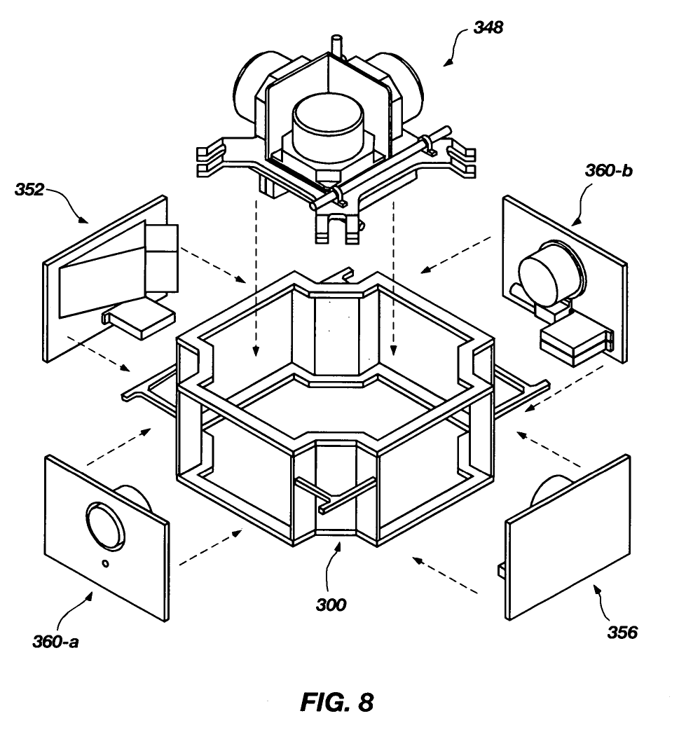

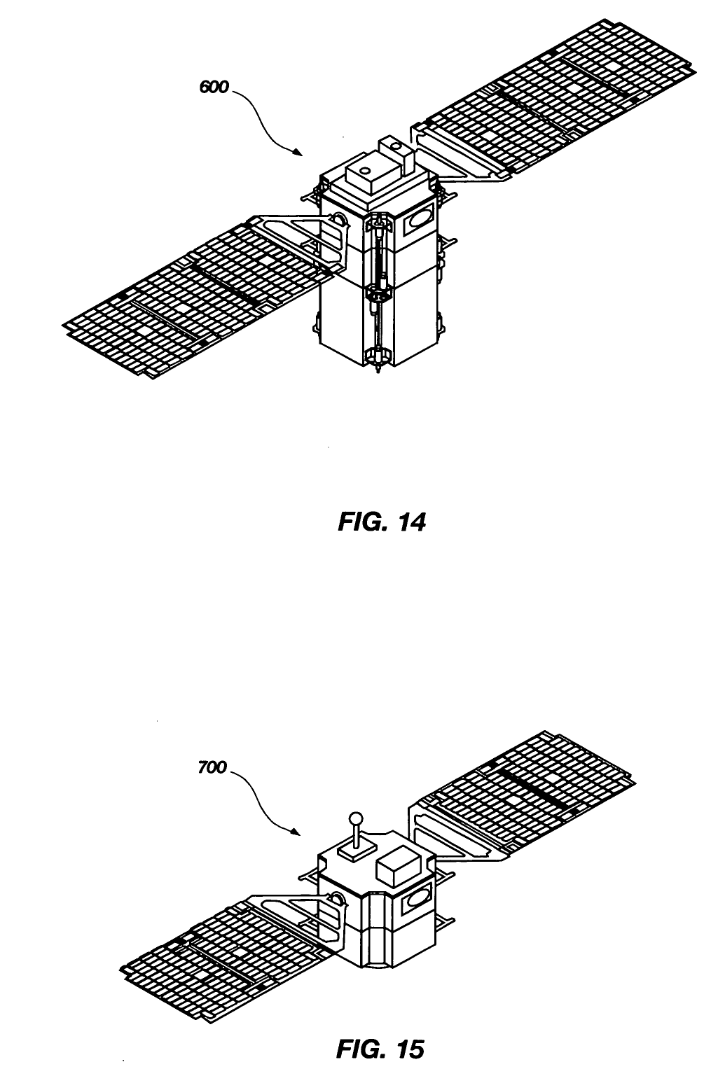

With reference to FIG. 8, illustrated is an exploded view of a top section of a rendezvous satellite variant, which satellite variant is comprised of three sections (see FIG. 14). As shown, the top section of the rendezvous satellite comprises an attitude control structural module 300 configured to provide the necessary structural support for coupling the various attitude control modules that are part of the attitude control subsystem. In this particular embodiment, the attitude control modules configured to operably couple to and interface with the attitude control structural module 300 include the attitude control shelf module 344, the attitude control panel module 352, the attitude control panel module 356, and two solar array gimbal modules 360-a and 360-b, each of which are described more fully above.

It is contemplated that these modules will operably interface with one another in at least one of a mechanical, electrical, and/or fluid manner. For example, it is contemplated that the attitude control shelf module 344, attitude control panel modules 352 and 356, and solar array gimbal modules 360 will mechanically interface with the attitude control structural module 300 and each other using various known attachment or coupling means or systems to provide an assembled support structure comprising the top section of the rendezvous satellite variant. Although several different types of attachment or coupling means and/or systems may be used and are contemplated to attach or couple the various modules together, the embodiment shown in FIG. 8 utilizes a standardized bolted interface.

It is further contemplated that those appropriate modules configured to do so will electrically interface with at least one other module as needed and in accordance with the present invention, such as described above and shown in FIG. 5. Further, any fluid interface being required is also contemplated.

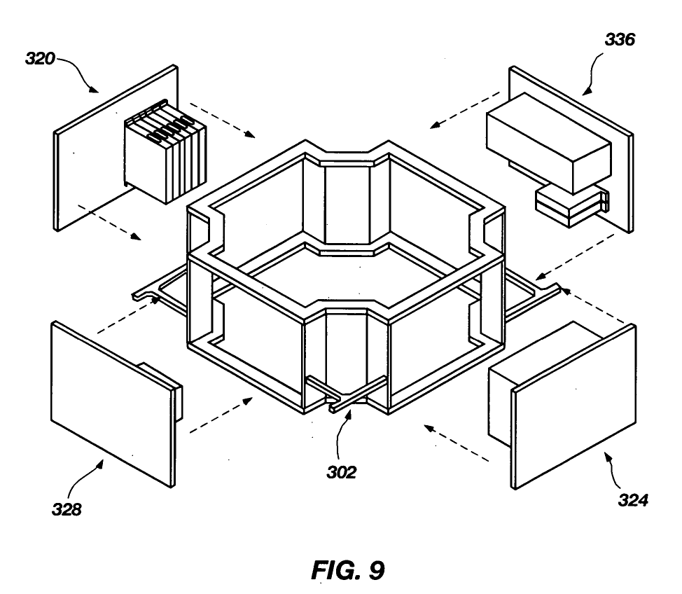

With reference to FIG. 9, illustrated is an exploded view of a central section of the rendezvous satellite variant. As shown, the central section comprises a command and data handling structural module 302 configured to provide the necessary structural support for coupling the various command and data handling modules that are a part of the command and data handling subsystem. In this particular embodiment, the command and data handling modules configured to operably couple to and interface with the command and data handling structural module 302 include a processor panel module 320, a first communications panel module 324 (transponder), a second communications panel module 328, and a power management panel module 336.

It is contemplated that these modules, similar to those modules making up the top section of the satellite, will operably interface with one another in at least one of a mechanical, electrical, and/or fluid manner.

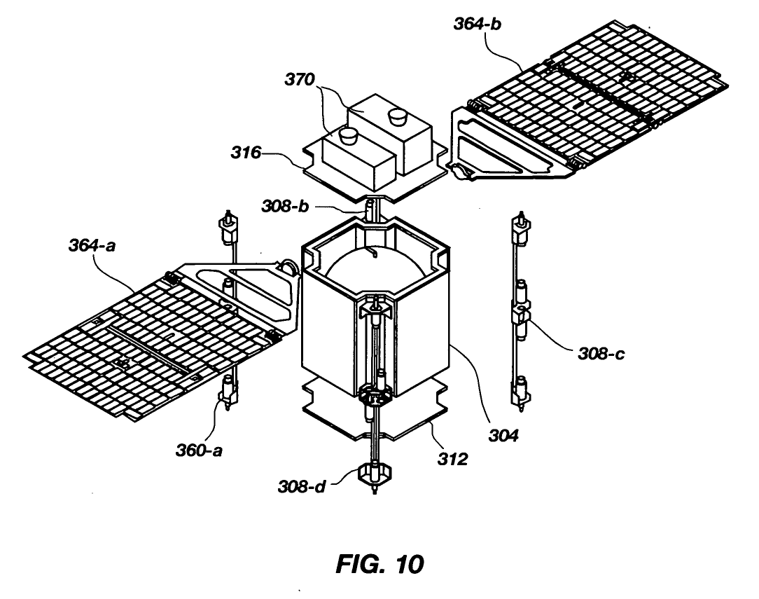

With reference to FIG. 10, illustrated is an exploded view of a bottom section of the rendezvous satellite variant. As shown, the bottom section comprises an exemplary propulsion module 304. Configured to operably interface with the propulsion module 304 is a thruster group of four thruster modules, shown as thruster modules 308-a, 308-b, 308-c, and 308-d. Launch interface deck module 312 and payload interface deck module 316 are each also configured to operably interface with the propulsion module 304. Each of these function to make up the bottom section of the satellite variant.

The bottom section further comprises a pair of solar array assembly modules, shown as solar array assembly modules 364-a and 364-b, and a payload 370 operably configured to interface with the payload interface deck module 316.

Similar to the other sections of the satellite, each of the various modules making up the bottom section are configured to operably interface with at least one other module via an electrical, a mechanical, and/or a fluid interface.

With reference to FIGS. 8-10, each of the top, central, and bottom sections are configured to operably interface with one another to construct or form the assembled rendezvous satellite variant. The interface between these sections may include mechanical, electrical, and/or fluid interfaces, as required. It is noted that although the components of an exemplary rendezvous satellite variant were illustrated and explained in FIGS. 8-10, a similar description and similar illustrations may be shown for any other constructed satellite variant. As such, the discussion and illustrations of FIGS. 8-10 are not to be construed as limiting the present invention to the particular satellite variant shown. Indeed, these other variants may be constructed using the same or similar mechanical, electrical, and fluid interface types, even though different modules may be selected to construct the satellite. In other words, each of the modules used to construct the different satellite variants may use the same or similar interface types as those used to construct the rendezvous satellite, despite the fact that the various modules may perform the same or a different function.

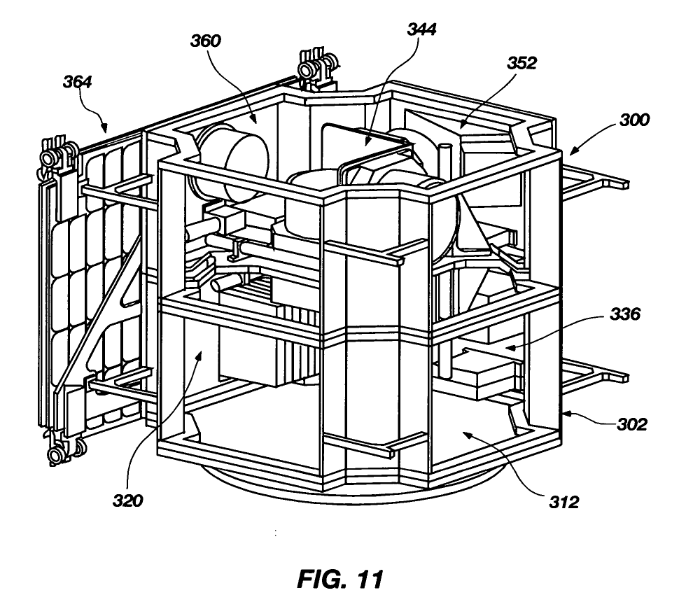

With reference to FIG. 11, illustrated is a partial, perspective view of a satellite variant shown in a stowed position and in an assembled, interfaced state with two sides open in order to view some of the various modules used to construct the satellite variant. Particularly, the satellite variant is shown as comprising an attitude control structural module 300 operably interfaced with a command and data handling structure module 302. The attitude control structural module 300 is shown as operably being interfaced with an attitude control shelf module 344, an attitude control panel module 352, and a solar array gimbal module 360.

The satellite variant further comprises a power management module 336 operably interfaced with the command and data handling structure module 302, and a solar array assembly module 364 operably interfaced with the attitude control structural module 300. Obviously, as one skilled in the art will recognize, the satellite variant is incomplete in that the top and two sides are open, thus not permitting the illustration of the additional modules that would make up the entire satellite variant. In any event, this figure illustrates the assembled interface of several different modules with each other. It is the collective interface and function of these several modules, as a group, that define the satellite structure and its performance capabilities. As can be seen, the top-level down approach provides a way to manufacture and construct entire satellite variants from a set of defined modules, wherein each of the modules are part of a modular platform based on a modular platform architecture. As such, the satellite variants may be fully modular, rather than partially modular.

Based on the historical use of satellites, and particularly small satellites, the various mission types these small satellites are designed to perform can be grouped into several identified mission categories, namely, communications, remote sensing, rendezvous, science, and technology demonstration, and responsive space. A brief description of each of the mission types is provided below. Each respective description is certainly not exhaustive, and thus these are not to be construed as limiting the present invention in any way. It is obvious that other functions or tasks or capabilities may be realized; indeed, the modular platform is design to be adaptable to new tasks or capabilities.

Communications missions typically require considerable power and large high-gain antennas. Small satellites have limited volume and power, thus limiting their capabilities. However, small satellites have been and can be used for the relay of communications streams, lower powered paging services, and low powered or low data rate direct communications missions. A small satellite could fill a direct or relay communications role to supplement a higher-value, more capable satellite, thereby increasing the effective range of communications links. Possible communications missions include, but are not limited to, direct communications, communications relay, and paging service.

Remote sensing missions include the remote imaging and remote detection of signals. Remote imaging covers a wide range of objectives and methods, from visible or infrared imaging to radar mapping. The wavelength, resolution, field of view, and timing of images are mission specific and vary considerably. Small satellites have payload capacity limitations (particularly power, mass, and volume) that constrain the performance capabilities to some degree. Telescope dimensions are not highly compressible without trading image quality, for example. Improvement in performance can be expected in the future as detector sensitivities and sizes improve. Possible remote imaging missions include, but are not limited to, infrared imaging, weather imaging, radar imaging, and visible imaging.

Rendezvous missions are perhaps one of the most complex categories of missions, and perhaps the most intriguing. They include the interception and rendezvous of a small satellite and another orbiting object. This group of missions requires a much more robust attitude determination and control system than most other missions, but is particularly well suited to a small, technologically advanced satellite. Small satellites could be rapidly launched, enabling responsive mission completion, and could be inexpensive enough that a short mission lifetime would be acceptable. Possible rendezvous missions include, but are not limited to, inspection, repair, shadow, and refuel.

Science missions can encompass numerous possibilities, even excluding the remote sensing missions covered previously. Atmospheric studies, studies of the magnetosphere, small telescopes, and microgravity experiments could all be conducted using small satellites. There are some limits to how small a telescope can become before the current technology used in detectors is not sufficient to be useful with the laws of physics working against size reduction. In-situ measurements of Earth's atmosphere, particularly low resolution measurements taken in numerous locations, whether chemical, magnetic, electrical, or thermal in nature, is well suited to constellations of small satellites. A constellation of small satellites, taking measurements over a large spatial area, if not globally, could supply key space weather insight that larger, sparsely distributed, and highly sophisticated space weather satellites cannot.

Technology demonstration missions are generally designed to provide on-orbit characterization and space qualification to components or technologies under development. A small satellite platform is ideal for this type of mission because of its low cost and shortened development cycle. Moreover, placing a payload on a small satellite rather than on a much larger satellite, where failure of the payload may mean the failure of the entire spacecraft reduces mission risk. The primary limitations for small satellites are their small size, limiting what can be demonstrated, and the ability to demonstrate a full system. Possible technology missions are numerous. For example, some technology demonstration missions may include, but are not limited to, pathfinder, component validation, materials validation, procedure validation, software validation, and target.

Responsive space missions are more a mission approach than a mission type. However, missions for responsive space include such areas as tactical imagery of current or future battlefields, communications gap fillers, and various rendezvous missions that have already been discussed. This category could be broken down into two general groups of responsive space missions, namely responsive satellite development missions and rapid launch missions. The concept of responsive satellite development is the rapid creation of a new satellite for a new mission, with the intent of reducing the development time to months instead of years. The second group is similar to the munitions concept, where the satellites and one or more payloads are prepared and stored awaiting activation and launch. For this group, the timely activation and launch is critical. These types of satellite missions could incorporate the same type of capability that allows munitions to install multiple warhead or targeting modules just prior to use, enabling multiple missions to be accomplished with a common set of hardware. Possible responsive space missions include, but are not limited to, tactical imagery, tactical communications, rapid technology development, and rapid rendezvous.

Corresponding to each mission identified above, a set of reference missions may be identified that identify the majority of requirements and/or functions a satellite might need to perform a particular type of mission. The satellites constructed or created using the present invention modular platform architecture may be configured with these different missions in mind.

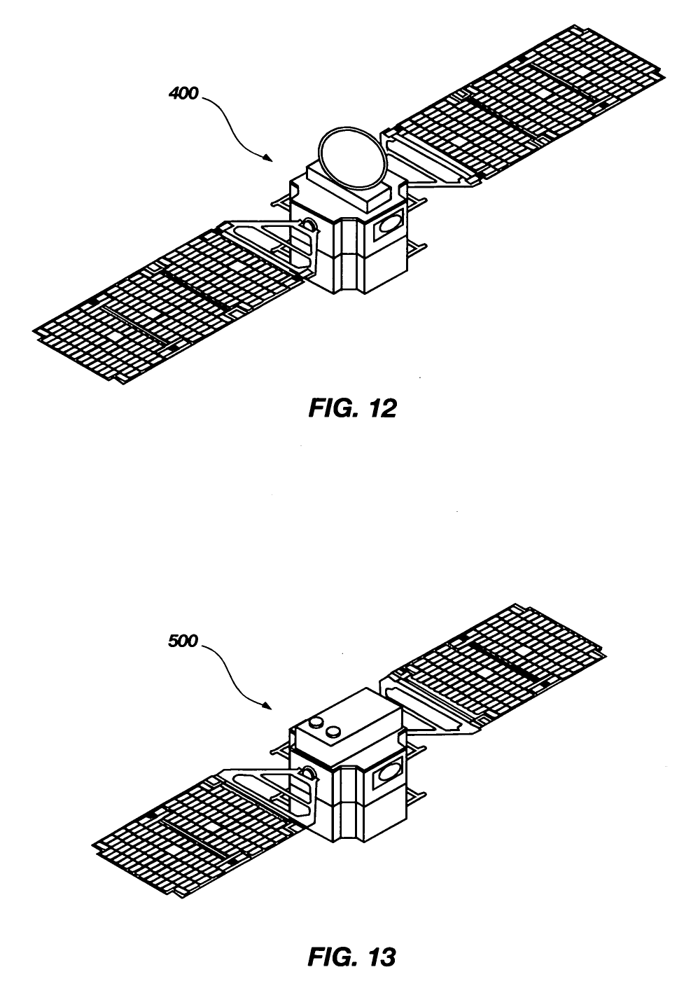

The following description sets forth the various satellite variants designed to meet or exceed the requirements of each of the individually designed DRMs previously discussed. With reference to FIG. 12, illustrated is a perspective view of one exemplary variant of a satellite based on the present invention modular platform and constructed from the several modules described herein. Specifically, FIG. 12 illustrates a satellite 400 intended for a communications mission. The communications variant uses a communications panel design that incorporates a power amplifier to boost RF power. At over 250 W, this variant requires the largest power generation capability of all the satellites, but is able to take advantage of the low solar inclination angle to produce the required power from two of the 3-panel solar array modules.

With reference to FIG. 13, illustrated is a perspective view of another exemplary variant of a satellite based on the present invention modular platform and constructed from the several modules described herein. Specifically, FIG. 13 illustrates a satellite 500 intended for a remote sensing mission. The remote sensing variant design is similar to the communications variant. This spacecraft has a lower power requirement, at 159 W, allowing the use of the smaller 2-panel solar array modules and the smaller 3.6 Amp-hour battery module. The power amplifier used on the communications variant is also not required.

With reference to FIG. 14, illustrated is a perspective view of another exemplary variant of a satellite based on the present invention modular platform and constructed from the several modules described herein. Specifically, FIG. 14 illustrates a satellite 600 intended for a rendezvous mission. The largest and most unique of all the designs is the rendezvous variant. This variant has the same processing and communications modules as the remote sensing variant, but includes a large propulsion module and four of the thruster modules that are designed to attach at each corner. With the inclusion of propulsion capability, this variant does not require the torque rods used by other variants for desaturation of the momentum wheels. Although the power consumption on the rendezvous variant is only slightly higher than that of the remote sensing variant, the larger 3-panel solar array module and larger 8.0 amp-hour battery module were selected to provide greater margin during maneuvers.

With reference to FIG. 15, illustrated is a perspective view of another exemplary variant of a satellite based on the present invention modular platform and constructed from the several modules described herein. Specifically, FIG. 15 illustrates a satellite 700 intended for a science mission. The science constellation variant is the smallest and simplest of all the designs. With only 148 W of required power, this spacecraft uses the smaller 2-panel solar array modules and the smaller 3.6 amp-hour battery module. The processing, communications, and attitude control modules are designed to exceed the performance requirements of this mission. Using the modular platform architecture for this variant and mission is expected to provide significant financial, schedule, and risk benefits over a conventional unique satellite design.

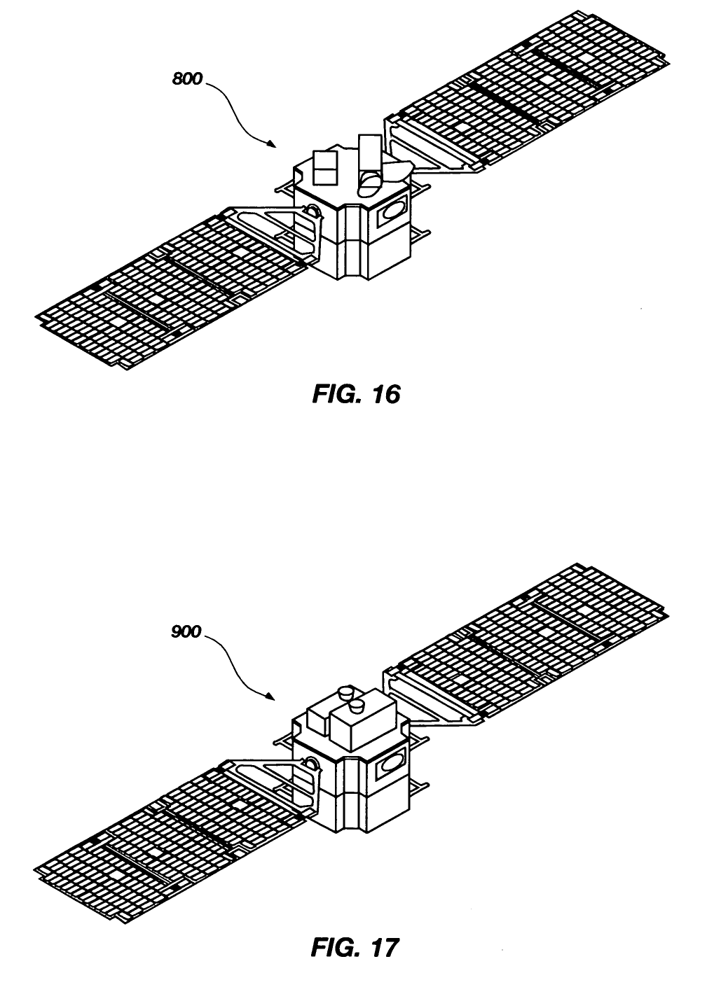

With reference to FIG. 16, illustrated is a perspective view of another exemplary variant of a satellite based on the present invention modular platform and constructed from the several modules described herein. Specifically, FIG. 16 illustrates a satellite 800 intended for a technology demonstration mission. The technology demonstration variant is identical to the remote sensing variant except that it uses the larger 3-panel solar array modules. The technology demonstration variant has a solar incidence angle that can vary from 0 to 45° (for inclinations greater than 45°, the spacecraft is rotated 90° about the velocity vector to minimize the solar incidence angle). For the worst case 450 incidence angle assumed for this design, the power generated from the 2-panel solar array modules is just below the amount required. The smaller solar array modules could be used if the satellite is placed in a higher or lower inclination orbit. Using one 2-panel solar array module and one 3-panel solar array module on the same spacecraft is an option, although this will cause a small imbalance of the torques on the spacecraft from atmospheric drag and solar flux.

With reference to FIG. 17, illustrated is a perspective view of another exemplary variant of a satellite based on the present invention modular platform and constructed from the several modules described herein. Specifically, FIG. 17 illustrates a satellite 900 intended for a rendezvous mission. The responsive space variant is assumed to have an accelerated schedule in order to place a payload into orbit as rapidly as possible. This variant fits well within the platform concept, particularly if it is assumed that the mission occurs after each of the required modules are designed, built, tested, and flight-proven on previous missions. This variant uses the same modules already used on the remote sensing or communications variants (as well as others). The processes, procedures, handling equipment, and ground support hardware would also be available. Experience with existing on-orbit resources would allow mission operations and activation and checkout of the satellite to be streamlined and would reduce mission risk. With all of these elements factored in, the cost, schedule, and risk would be significantly lower than that for developing a new satellite.

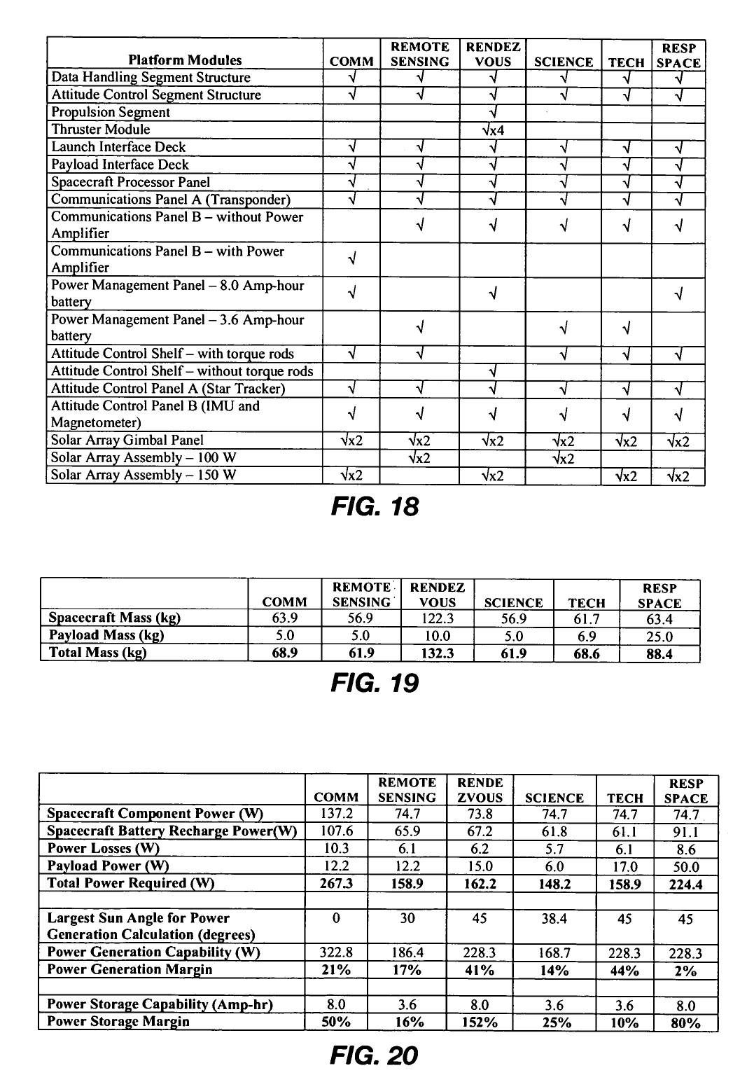

With reference to FIG. 18, illustrated is a table identifying each of the present invention modules utilized in the several exemplary platform satellite variants just described. Specifically, FIG. 18 identifies each exemplary satellite variant described herein, and the various modules that may be used to construct such variants.

FIG. 19 illustrates a table summarizing the spacecraft, payload, and total mass for each of the exemplary platform satellite variants just described. These numbers are not intended to be limiting in any way.

FIG. 20 illustrates a summary of power for each of the several exemplary platform satellite variants just described. These numbers are not intended to be limiting in any way.

In regards to the launch options for the various platform satellite variants, the platform variants may be designed to fit within the Evolved Expendable Launch Vehicle (EELV) Secondary Payload Adapter (ESPA) standard envelope. However, the module shapes and sizes presented herein may be adapted to many different envelopes. The most promising options for the platform variants are shared rides on a dedicated launch vehicle or secondary payload rides on the ESPA.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given above.

1. (canceled)

2. A method for implementing a modular platform for the construction of satellites and other spacecraft based on modular platform architecture, said method comprising:
identifying a plurality of functional elements and their associated functional routines that may be operable within at least one satellite;
associating said functional routines with one another in a strategic manner;
defining a plurality of subsystems from said functional elements, and any divisions thereof; and
deriving a plurality of modules from said plurality of subsystems, each of said modules being configured to operably interface with at least one other module to construct said satellite capable of carrying out at least one of said functional routines, said satellite being constructed substantially from said plurality of modules.

3. The method of claim 2, wherein a set of said plurality of said modules may be selected to construct a variant of said satellite.

4. The method of claim 2, wherein said modules, or a component thereof, may be selectively interchanged to construct a plurality of variants of said satellite intended for different mission types.

5. The method of claim 2, further comprising reconfiguring said modules to meet different mission types.

6. The method of claim 2, further comprising standardizing one or more interfaces between said modules to enable an increased degree of commonality between different variants of said satellite.

7. The method of claim 2, further comprising optimizing said modular platform for at least one of flexibility, standardization, and manufacturability.

8. The method of claim 2, wherein said functional elements are selected from the group consisting of power management, spacecraft processor, communications, separation system, payload interface, attitude control, attitude determination, and propulsion functional elements.

9. A method for constructing a satellite from a modular platform based on modular platform architecture, said method comprising:
obtaining a plurality of modules, each of said modules facilitating execution of at least one function of a functional routine of said satellite, and each being derived from at least one subsystem defined by at least one functional element;
selecting a set of said plurality of modules to be used to construct said satellite configured to conduct an intended mission, said satellite being constructed substantially from said set of said modules; and
operably interfacing each of said modules within said set with at least one other module in said set to construct said satellite capable of performing all required and optional functional routines, said satellite being constructed substantially from said set of said modules.

10. The method of claim 9, further comprising interchanging at least one of said modules within said set with at least one other module to construct a variant of said satellite.

11. The method of claim 9, wherein said interfacing is selected from the group consisting of mechanical, electrical, fluid, data, and any combination of these.

12. The method of claim 9, wherein said interfacing comprises directly interfacing said modules with one another.

13. The method of claim 9, wherein said interfacing comprises interfacing said modules with one another via an electrical backbone.

14. A modular platform for use in constructing a satellite and variants thereof, said modular platform being based on modular platform architecture, and comprising:
a plurality of modules, each being derived from at least one subsystem, and each being configured to operably interface with at least one other module to construct a working satellite capable of carrying out said functional routines,
said modules being derived from a plurality of subsystems corresponding to and defined by a plurality of functional elements and functional routines,
said subsystems being defined by a plurality of functional elements and their associated functional routines that identify and control various operations and functions of said satellite, said functional elements being strategically divided to form said functional routines, said functional routines being strategically associated with one another.

15. The modular platform of claim 14, wherein said plurality of subsystems is selected from the group consisting of a payload subsystem, an attitude control subsystem, a command and data handling subsystem, a propulsion subsystem, a power subsystem, and a structure subsystem, each being based on a corresponding, like functional element.

16. The modular platform of claim 14, wherein said modules further comprise components configured to perform a pre-determined function and to facilitate execution of a functional routine of said satellite.

17. A satellite configured for use in performing a mission, said satellite comprising:
a plurality of independent modules selected and assembled from a modular platform based on modular platform architecture, each of said plurality of modules being derived from a plurality of subsystems, and configured to perform a pre-determined functional routine; and
means for interfacing each of said plurality of modules with at least one other module in an operable manner to construct said satellite and to facilitate the performance of all functional routines capable of being performed by said satellite.

18. The satellite of claim 17, wherein said means for interfacing comprises a mechanical interface configured to physically interconnect said modules.

19. The satellite of claim 17, wherein said means for interfacing comprises an electrical interface configured to electrically couple said modules.

20. The satellite of claim 17, wherein said means for interfacing comprises a software interface configured to control the functions of said modules.

21. The satellite of claim 17, wherein said means for interfacing comprises a data interface.

22. The satellite of claim 17, wherein said means for interfacing comprises a fluid interface configured to permit the transfer of fluid between modules.

23. The satellite of claim 17, wherein said plurality of modules is selected from the group consisting of a data handling structural module, an attitude control structural module, a propulsion module, a launch interface deck module, a payload interface deck module, a spacecraft processor panel module, a communications panel module, a power management panel module, a power management panel module, an attitude control shelf module, an attitude control panel module, a solar array gimbal panel module, and a solar array assembly module, each of these being based on corresponding subsystems.

24. The satellite of claim 17, wherein a set of said plurality of modules may be selected and varied to form specific variants of said satellite.

25. The satellite of claim 17, wherein at least some of said plurality of modules further comprise various other components supported thereon that are configured to perform a pre-determined function.

26. The satellite of claim 17, further comprising a connector that physically couples said modules together.

27. The satellite of claim 17, wherein at least one of said modules is generic, and capable of being utilized across a number of different satellite variants.

28. The satellite of claim 17, wherein at least one of said modules is variant-specific.
